(19) United States
(12) Patent Application Publication
(10) Pub. No.: US 2017/0169281 A1
(43) Pub. Date: Jun. 15, 2017

(54) FINGERPRINT RECOGNITION SYSTEM OF PORTABLE ELECTRONIC DEVICE

(71) Applicants: WEN-KUEI LIU, Taichung City (TW); CHAO-HSUAN LIU, Taichung City (TW); YU-CHUN LIU, Taichung City (TW)

(72) Inventors: WEN-KUEI LIU, Taichung City (TW); CHAO-HSUAN LIU, Taichung City (TW); YU-CHUN LIU, Taichung City (TW)

(21) Appl. No.: 15/361,256

(22) Filed: Nov. 25, 2016

(30) Foreign Application Priority Data
Dec. 11, 2015 (TW) 104141751

(51) Int. Cl. G06K 9/00; G06K 9/52

(52) U.S. Cl. CPC G06K 9/00087; G06K 9/00375; G06K 9/52

(57) ABSTRACT

A fingerprint recognition system of a portable electronic device is provided, including a database, a detecting unit and a processing unit which are electrically connected to the processing unit, the database including a contrast data module which includes fingerprint characteristic data and knuckle characteristic data of three preset fingers, the detecting unit for detecting fingerprints and knuckles to be inspected of three fingers to be inspected and transmitting a signal to the processing unit, the processing unit transferring the signal into a real-time data module, the processing unit contrasting the real-time data module and the contrast data module to obtain a verification match rate, the processing unit having a preset match rate, wherein when the verification match rate is greater than or equal to the preset match rate, the processing unit determines that the three fingers to be inspected match the three preset fingers.

### BACKGROUND OF THE INVENTION

Field of the Invention

The present invention relates to a fingerprint recognition system, and more particularly to a fingerprint recognition system of a portable electronic device.

Description of the Prior Art

Everyone is born with different biological characteristics, for example, fingerprints, faces, irises or other body parts. Therefore, since traditional password locks or ID cards are often lost, forgotten or hacked, using biological characteristics to identify identities has greater security and more precise recognition. Nowadays, people highly rely on electronic products (for example, mobile phone, tablets or notebooks), and there are often personal files or data saved in the electronic products; therefore, in order to increase the security of the private information, the industry applied the biological characteristics into the electronic products, and such fingerprint recognition systems are disclosed in TWI492119 and TWM504287.

In a common fingerprint recognition system, a fingerprint of just one finger is logged into a database, so once the fingerprint to be recognized is broken (for example, when a user got hurt on the finger), the fingerprint becomes unrecognizable. To solve the above-mentioned problem, TW201528120 logs fingerprints of ten fingers, one of the ten fingers as a main recognition, and the other nine fingers are alternative recognitions.

However, the prior art only takes the fingerprints of the fingers to conduct recognition and has a lower security. In addition, logging multiple sets of the fingerprints into the database would increase the security risk of using the electronic products because this way provides more opportunities for evil people to obtain different fingerprint samples and use fake fingerprints to log in.

The present invention has arisen to mitigate and/or obviate the afore-described disadvantages.

### SUMMARY OF THE INVENTION

The major object of the present invention is to provide a fingerprint recognition system of a portable electronic device, when a user got hurt on a finger which is used for recognition, s/he can still conduct fingerprint recognition. In addition, a plurality of combination modes are provided for higher security.

To achieve the above and other objects, a fingerprint recognition system of a portable electronic device is provided, including a database, a detecting unit and a processing unit, the database and the detecting unit respectively electrically connected to the processing unit, the database including a contrast data module, the contrast data module including a plurality of fingerprint characteristics data and a plurality of knuckle characteristics data of three preset fingers, the detecting unit for detecting a plurality of fingerprints to be inspected and a plurality of knuckles to be inspected of three fingers to be inspected and transmitting a signal to the processing unit, the processing unit transferring the signal into a real-time data module after receiving the signal, the processing unit contrasting the real-time data module and the contrast data module to obtain a verification match rate. The processing unit has a preset match rate, and when the verification match rate is greater than or equal to the preset match rate, the processing unit determines that the three fingers to be inspected match the three preset fingers.

The present invention will become more obvious from the following description when taken in connection with the accompanying drawings, which show, for purpose of illustrations only, the preferred embodiment(s) in accordance with the present invention.

### BRIEF DESCRIPTION OF THE DRAWINGS

FIG. 1 is a block diagram showing relations of members of an embodiment of the present invention;

FIG. 2 is a drawing showing a recognition process of the embodiment of the present invention;

FIG. 3 is a first view of fingers to be inspected of the embodiment of the present invention;

FIG. 4 is a drawing showing the embodiment of the present invention in use;

FIG. 5 is a second view of the fingers to be inspected of the embodiment of the present invention;

FIG. 6 is a third view of the fingers to be inspected of the embodiment of the present invention;

FIG. 7 is a fourth view of the fingers to be inspected of the embodiment of the present invention;

FIG. 8 is a fifth view of the fingers to be inspected of the embodiment of the present invention; and

FIG. 9 is a sixth view of the fingers to be inspected of a preferred embodiment of the present invention.

### DETAILED DESCRIPTION OF THE PREFERRED EMBODIMENTS

The present invention will be clearer from the following description when viewed together with the accompanying drawings, which show, for purpose of illustrations only, the preferred embodiment in accordance with the present invention.

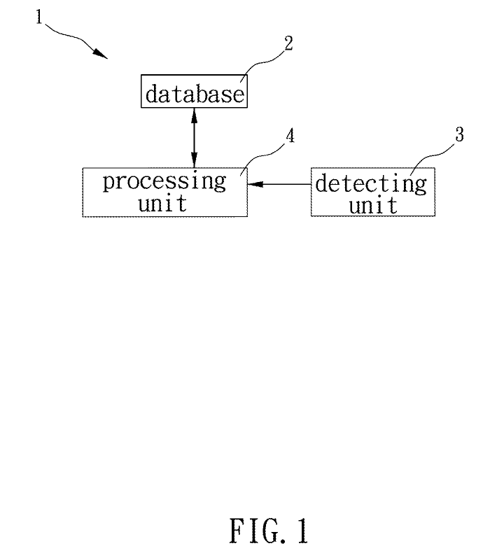

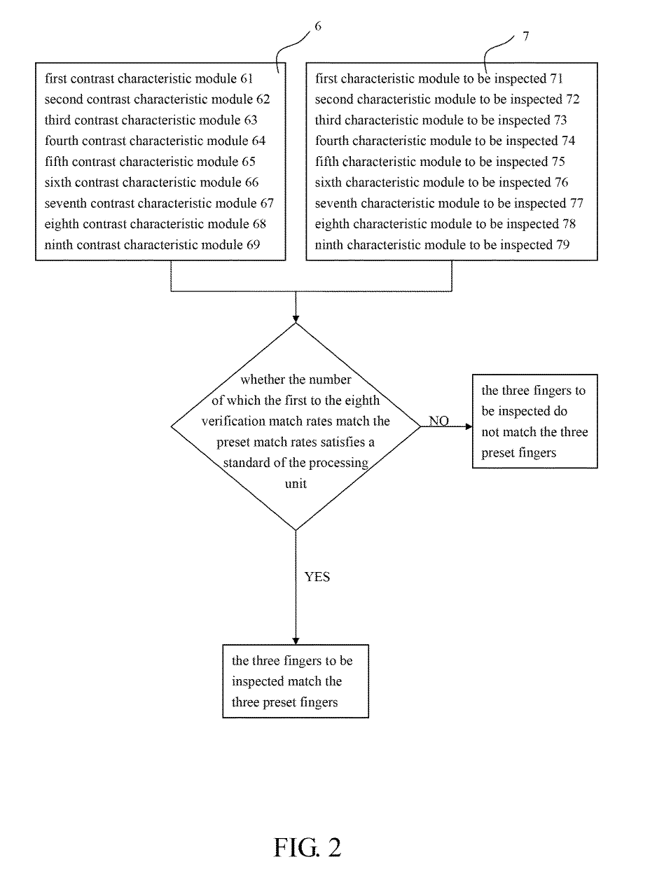

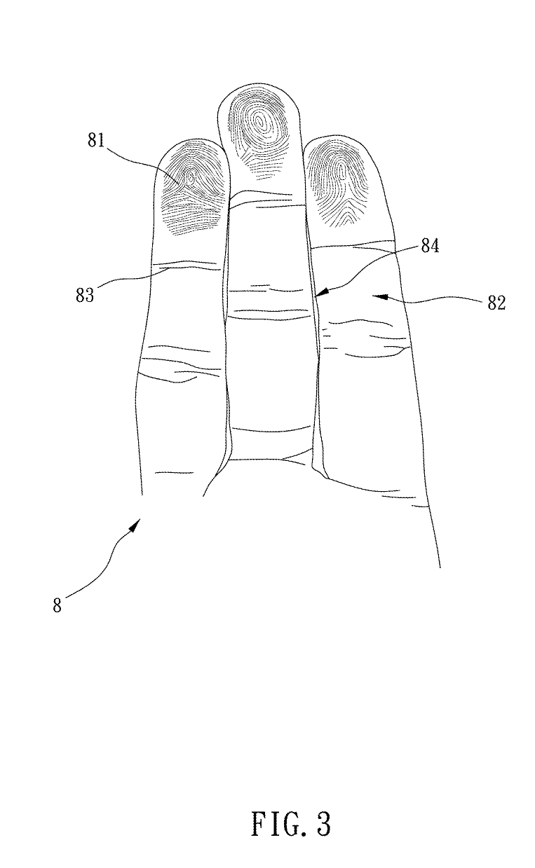

Please refer to FIGS. 1 to 4 for a preferred embodiment of the present invention. A fingerprint recognition system 1 of a portable electronic device 5 includes a database 2, a detecting unit 3 and a processing unit 4. The database 2 and the detecting unit 3 are respectively electrically connected to the processing unit 4, the database 2 includes a contrast data module 6, the contrast data module 6 includes a plurality of fingerprint characteristics data and a plurality of knuckle characteristics data of three preset fingers (not shown), the detecting unit 3 is for detecting a plurality of fingerprints to be inspected 81 and a plurality of knuckles to be inspected 82 of three fingers to be inspected 8 and transmitting a signal to the processing unit 4, the processing unit 4 transfers the signal into a real-time data module 7 after receiving the signal, and the processing unit 4 contrasts the real-time data module 7 and the contrast data module 6 to obtain a verification match rate. The processing unit 4 has a preset match rate, and when the verification match rate is greater than or equal to the preset match rate, the processing unit 4 determines that the three fingers to be inspected 8 match the three preset fingers. A user can use the fingerprint recognition system 1 as a way to unlock, for example, an operation screen or files of the portable electronic device 5 so as to protect electronic data which are more important.

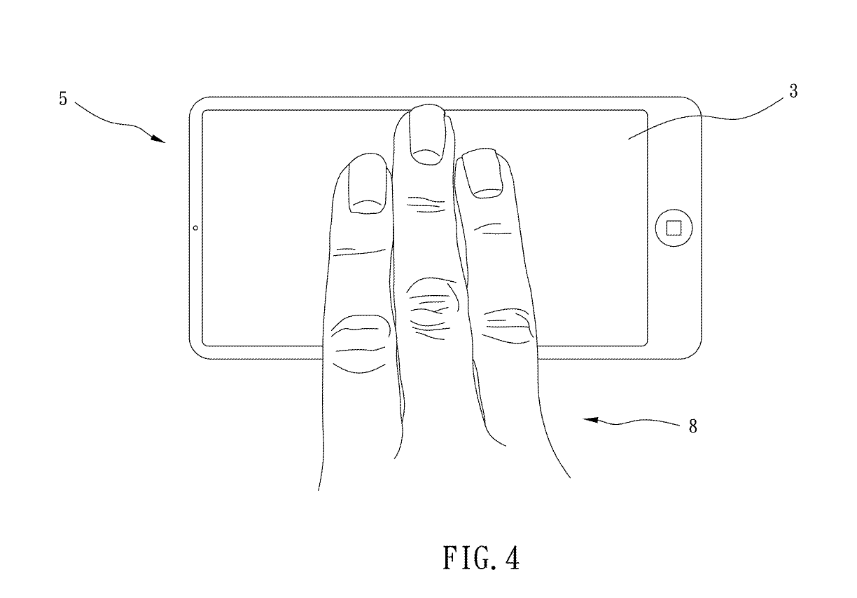

In addition, considering that when the three fingers to be inspected 8 of the user got hurt or dirty, it is difficult to determine a verification result and requires higher verification reliability and security. Therefore, it is recommended that the preset match rate is preferably defined between 70% to 90%, and in this embodiment, the preset match rate is 80% for recognition convenience and security. It is to be noted that the three preset fingers are not limited to a hand or a foot of the user and not limited to one hand/foot, and in other words, the three preset fingers may have a plurality of combinations. Preferably, the three preset fingers and the three fingers to be inspected 8 respectively include a forefinger, a middle finger and a ring finger of a single hand so that it is convenient for the user to conduct a recognition process on the portable electronic device 5 (as shown in FIG. 4).

Specifically, the contrast data module 6 includes a first contrast characteristic module 61 and a second contrast characteristic module 62, the first contrast characteristic module 61 is defined as the plurality of fingerprint characteristics data of the three preset fingers, and the second contrast characteristic module 62 is defined as the plurality of knuckle characteristics data of the three preset fingers, for example but not limited to, shapes of the knuckle prints, a number of main lines of the knuckle prints, distribution positions of the knuckle prints on the knuckles and a length of each said knuckle print. It is understandable that the real-time data module 7 includes a first characteristic module to be inspected 71 and a second characteristic module to be inspected 72, the first characteristic module to be inspected 71 is data of the plurality of fingerprints to be inspected 81 of the three fingers to be inspected 8, and the second characteristic module to be inspected 72 is data of the plurality of knuckle prints to be inspected 83 of the three fingers to be inspected 8. The processing unit 4 respectively contrasts the first and second characteristic modules 71, 72 to be inspected as well as the first and second contrast characteristic modules 61, 62 and obtains a first verification match rate and a second verification match rate. When at least one of the first and second verification match rates is greater than or equal to the preset match rate, the processing unit 4 determines that the three fingers to be inspected 8 match the three preset fingers.

Preferably, the contrast data module 6 includes a third contrast characteristic module 63, the third contrast characteristic module 63 is data of two finger gap characteristics of the three preset fingers which stretch straightly and contact each other, the real-time data module 7 further includes a third characteristic module to be inspected 73, the third characteristic module to be inspected 73 is data of two finger gaps to be inspected of the three fingers to be inspected 8 which stretch straightly and contact each other, the processing unit 4 contrasts the third characteristic module to be inspected 73 and the third contrast characteristic module 63 and obtains a third verification match rate. When at least two of the first, second and third verification modules are greater than or equal to the preset match rate, the processing unit 4 determines the three fingers to be inspected 8 match the three preset fingers; therefore, the three fingers to be inspected 8 can still used for verification even if the three fingers to be inspected 8 are wounded, and a verification security will not be influenced.

Preferably, the contrast data module 6 further includes a fourth contrast characteristic module 64, and the fourth contrast characteristic module 64 is data of a plurality of knuckle print relative position characteristics of the three preset fingers which stretch straightly and contact each other, for example, a second knuckle print of the forefinger substantially corresponds to a second knuckle print of the middle finger, or a first knuckle print of the ring finger is in a first half of a finger gap between the middle finger and the ring finger. The real-time data module 7 further includes a fourth characteristic module to be inspected 74, the fourth characteristic module to be inspected 74 is data of a plurality of knuckle print relative positions to be inspected 83 of the three fingers to be inspected 8 which stretch straightly and contact each other, the processing unit 4 contrasts the fourth characteristic module to be inspected 74 and the fourth contrast characteristic module 64 and obtains a fourth verification match rate. When at least two of the first, second, third and fourth verification modules are greater than or equal to the preset match rate, the processing unit 4 determines the three fingers to be inspected 8 match the three preset fingers.

It is to be noted that the user can decide how many of the first, second, third and fourth verification match rates need to match the preset match rate (for example, 2, 3 or 4) so as to adjust a strictness of a determination of the processing unit 4. For example, if the user wants to ensure the security of the verification, the user can set that when each of the first, second, third and fourth verification match rates is greater than or equal to the preset match rate, the processing unit 4 determines the three fingers to be inspected 8 match the three preset fingers.

In addition, the contrast data module 6 can be expanded or added with other preset recognition data.

For example, the three preset fingers and the three fingers to be inspected 8 respectively include the forefinger, the middle finger and the ring finger of the single hand, the contrast data module 6 further includes a fifth contrast characteristic module 65, when the three preset fingers strength straightly and contact each other, a first tangent line is defined to be tangent to a fingerprint contour of the middle finger and a fingerprint contour of the forefinger, a second tangent line is defined to be tangent to the fingerprint contour of the middle finger and a fingerprint contour of the ring finger, the first and second tangent lines of the three preset fingers cross with each other to form a preset included angle (not shown), and the fifth contrast characteristic module 65 is the included angle.

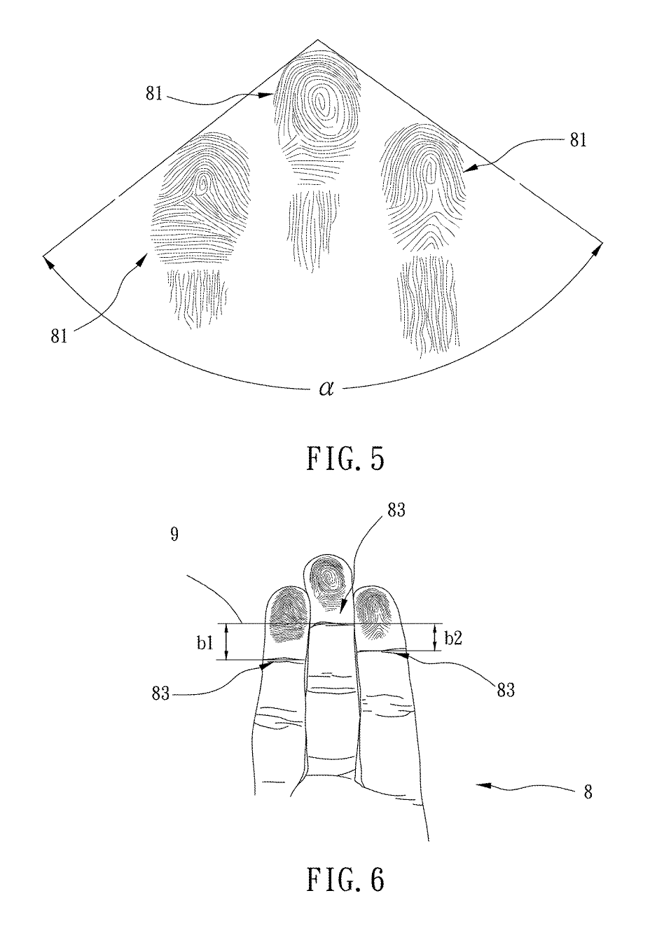

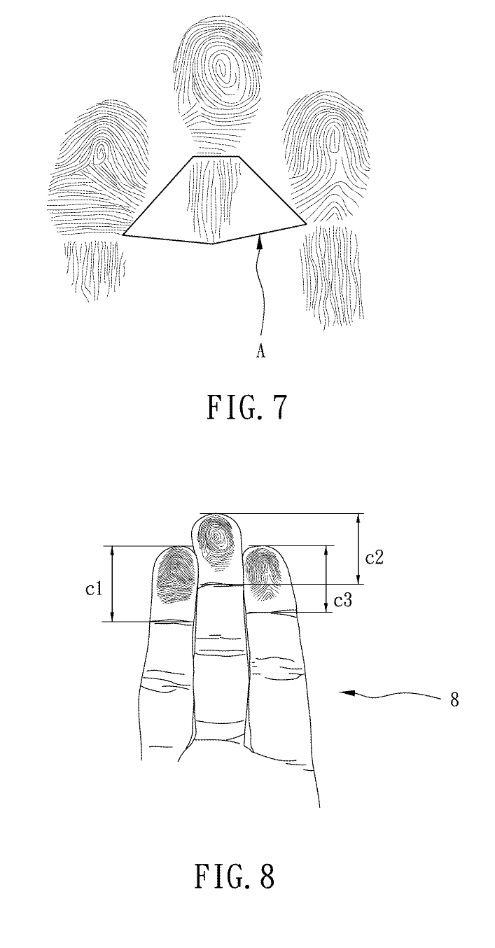

The real-time data module 7 further includes a fifth characteristic module to be inspected 75, please refer to FIG. 5, when the three fingers to be inspected 8 stretch straightly and contact each other, another first tangent line is defined to be tangent to the fingerprint contour of the middle finger and the fingerprint contour of the forefinger, another second tangent line is defined to be tangent to the fingerprint contour of the middle finger and the fingerprint contour of the ring finger, the first and second tangent lines of the three fingers to be inspected cross with each other to form an included angle to be inspected α, and the fifth characteristic module to be inspected 75 is the included angle to be inspected α. The processing unit 4 contrasts the fifth characteristic module to be inspected 75 and the fifth contrast characteristic module 65 and obtains a fifth verification match rate. When the fifth verification match rate is greater than or equal to the preset match rate, the processing unit 4 determines the three fingers to be inspected match the three preset fingers.

The contrast data module 6 further has a sixth contrast characteristic module 66, when the three preset fingers strength straightly and contact each other, a preset datum line (not shown) passes a knuckle print of a first knuckle of the middle finger, a distance between a knuckle print of a first knuckle of the forefinger and the preset datum line is a first preset distance, a distance between a knuckle print of a first knuckle of the ring finger and the preset datum line is a second preset distance, and the sixth contrast characteristic module 66 is data of the first and second preset distances.

The real-time data module 7 further include a sixth characteristic module to be inspected 76, please refer to FIG. 6, when the three fingers to be inspected 8 stretch straightly and contact each other, a datum line to be inspected 9 passes the knuckle print of the first knuckle of the middle finger, a distance between the knuckle print of the first knuckle of the forefinger and the datum line to be inspected 9 is a first distance to be inspected b1, a distance between the knuckle print of the first knuckle of the ring finger and the datum line to be inspected 9 is a second distance to be inspected b2, and the sixth characteristic module to be inspected 76 is data of the first and second distances to be inspected b1, b2. The processing unit 4 contrasts the sixth characteristic module to be inspected 76 and the sixth contrast characteristic module 66 and obtains a sixth verification match rate. When the sixth verification match rate is greater than or equal to the preset match rate, the processing unit 4 determines the three fingers to be inspected 8 match the three preset fingers.

The contrast data module 6 further includes a seventh contrast characteristic module 67, when the three preset fingers strength straightly and contact each other, a preset polygon (not shown) is defined through a plurality of preset characteristic points taken from the knuckle prints of the first knuckle and the second knuckle of the middle finger, the knuckle print of the first knuckle of the forefinger and the knuckle print of the first knuckle of the ring finger, and the seventh contrast characteristic module 67 is data of the preset polygon. The real-time data module 7 further includes a seventh characteristic module to be inspected 77, when the three fingers to be inspected 8 stretch straightly and contact each other, a polygon to be inspected A is defined through a plurality of characteristic points to be inspected taken from the knuckle prints of the first knuckle and the second knuckle of the middle finger, the knuckle print of the first knuckle of the forefinger and the knuckle print of the first knuckle of the ring finger, and the seventh characteristic module to be inspected 77 is data of the polygon to be inspected A. The processing unit 4 contrasts the seventh characteristic module to be inspected 77 and the seventh contrast characteristic module 67 and obtains a seventh verification match rate. When the seventh verification match rate is greater than or equal to the preset match rate, the processing unit 4 determines the three fingers to be inspected 8 match the three preset fingers.

In this embodiment, the plurality of characteristic points to be inspected which include two end points of the knuckle print of the first knuckle of the middle finger, a right end point of the knuckle print of the first knuckle of the forefinger, a left end point of the knuckle print of the first knuckle of the ring finger and a center of the knuckle print of the second knuckle of the middle finger forms a pentagon to be contrast with the preset polygon. It is understandable that the plurality of preset characteristic points are in same positions as the plurality of characteristic points to be inspected.

The contrast data module 6 further includes an eighth contrast characteristic module 68, when the three preset fingers strength straightly and contact each other, a distance between the knuckle print of the first knuckle of the forefinger to a finger tip of the forefinger is a first specified distance, a distance between the knuckle print of the first knuckle of the middle finger to a finger tip of the middle finger is a second specified distance, a distance between the knuckle print of the first knuckle of the ring finger to a finger tip of the ring finger is a third specified distance, and the eighth contrast characteristic module 68 is data of the first, second and third specified distances.

The real-time data module further include an eighth characteristic module to be inspected 78, please refer to FIG. 8, when the three fingers to be inspected 8 stretch straightly and contact each other, the distance between the knuckle print of the first knuckle of the forefinger to the finger tip of the forefinger is a first specified distance to be inspected c1, the distance between the knuckle print of the first knuckle of the middle finger to the finger tip of the middle finger is a second specified distance to be inspected c2, the distance between the knuckle print of the first knuckle of the ring finger to a finger tip of the ring finger is a third specified distance to be inspected c3, and the eighth characteristic module to be inspected 78 is data of the first, second and third specified distances to be inspected c1, c2, c3. The processing unit 4 contrasts the eighth characteristic module to be inspected 78 and the eighth contrast characteristic module 68 and obtains an eighth verification match rate. When the eighth verification match rate is greater than or equal to the preset match rate, the processing unit 4 determines the three fingers to be inspected match the three preset fingers.

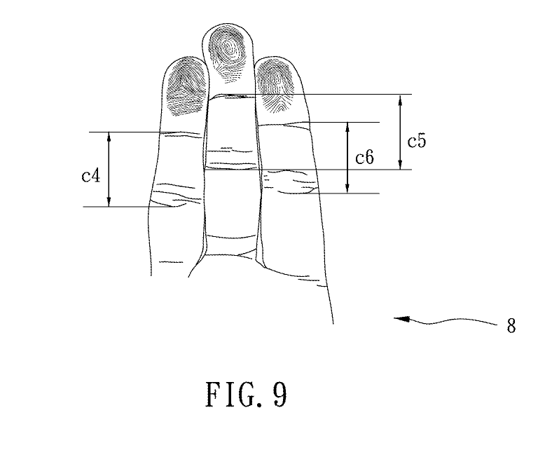

Please refer to FIG. 9, a distance between the knuckle print of the first knuckle and the knuckle print of the second knuckle of the forefinger of the three preset fingers is a fourth specified distance, a distance between the knuckle print of the first knuckle and the knuckle print of the second knuckle of the middle finger of the three preset fingers is a fifth specified distance, a distance between the knuckle print of the first knuckle and the knuckle print of the second knuckle of the ring finger of the three preset fingers is a sixth specified distance, the contrast data module further includes a ninth contrast characteristic module 69, and the ninth contrast characteristic module 69 is data of the fourth, fifth and sixth specified distances.

It is understandable that the real-time data module further includes a ninth characteristic module to be inspected 79, the distance between the knuckle print of the first knuckle and the knuckle print of the second knuckle of the forefinger of the three fingers to be inspected is a fourth specified distance to be inspected c4, the distance between the knuckle print of the first knuckle and the knuckle print of the second knuckle of the middle finger of the three fingers to be inspected is a fifth specified distance to be inspected c5, the distance between the knuckle print of the first knuckle and the knuckle print of the second knuckle of the ring finger of the three fingers to be inspected is a sixth specified distance to be inspected c6, and the ninth characteristic module to be inspected 79 is data of the fourth, fifth and sixth specified distances to be inspected c4, c5, c6. The processing unit contrasts the ninth characteristic module to be inspected 79 and the ninth contrast characteristic module 69 and obtains a ninth verification match rate. When the ninth verification match rate is greater than or equal to the preset match rate, the processing unit determines the three fingers to be inspected match the three preset fingers.

It is to be noted that the knuckle prints are different, so the fourth, fifth and sixth specified distances or the fourth, fifth and sixth specified distances to be inspected c4, c5, c6 vary according to positions of the knuckle prints. Therefore, the user can set a capturing standard according to personal habit or preference, for example but not limited to, the distances between the knuckle prints of the first knuckles and the knuckle prints of the second knuckles are farthest distances; or in other embodiments, the distances between the knuckle prints of the first knuckles and the knuckle prints of the second knuckles are shortest distances.

Given the above, the fingerprint recognition system of the portable electronic device can recognized a plurality of parts of the fingers so that there are a plurality of recognition modes. Therefore, even if the finger(s) of the user is/are wounded, s/he can still conduct fingerprint recognition.

In addition, through determining if the verification match rates, which are produced by contrasting the characteristic models to be inspected and the contrast characteristic models, exceed the preset match rate and finding a number of the verification rates exceeding the preset match rate, the verification precision is elevated. In addition, the user can decide the number of the verification rates exceeding the preset match rate to adjust the strictness of fingerprint recognition.

While we have shown and described various embodiments in accordance with the present invention, it should be clear to those skilled in the art that further embodiments may be made without departing from the scope of the present invention.

What is claimed is:

1. A fingerprint recognition system of a portable electronic device, including a database, a detecting unit and a processing unit, the database and the detecting unit respectively electrically connected to the processing unit, the database including a contrast data module, the contrast data module including a plurality of fingerprint characteristic data and a plurality of knuckle characteristic data of three preset fingers, the detecting unit for detecting a plurality of fingerprints to be inspected and a plurality of knuckles to be inspected of three fingers to be inspected and transmitting a signal to the processing unit, the processing unit transferring the signal into a real-time data module after receiving the signal, the processing unit contrasting the real-time data module and the contrast data module to obtain a verification match rate;
wherein the processing unit has a preset match rate, and when the verification match rate is greater than or equal to the preset match rate, the processing unit determines that the three fingers to be inspected match the three preset fingers.

2. The fingerprint recognition system of claim 1, wherein the preset match rate is defined as 70% to 90%.

3. The fingerprint recognition system of claim 1, wherein the three preset fingers and the three fingers to be inspected respectively include a forefinger, a middle finger and a ring finger of a single hand.

4. The fingerprint recognition system of claim 1, wherein the contrast data module includes a first contrast characteristic module and a second contrast characteristic module, the first contrast characteristic module is defined as the plurality of fingerprint characteristic data of the three preset fingers, the second contrast characteristic module is defined as the plurality of knuckle characteristics data of the three preset fingers; the real-time data module includes a first characteristic module to be inspected and a second characteristic module to be inspected, the first characteristic module to be inspected is data of the plurality of fingerprints to be inspected of the three fingers to be inspected, the second characteristic module to be inspected is data of the plurality of knuckle prints to be inspected of the three fingers to be inspected; the processing unit respectively contrasts the first and second characteristic modules to be inspected as well as the first and second contrast characteristic modules and obtains a first verification match rate and a second verification match rate; wherein when at least one of the first and second verification match rates is greater than or equal to the preset match rate, the processing unit determines that the three fingers to be inspected match the three preset fingers.

5. The fingerprint recognition system claim 4, wherein the contrast data module includes a third contrast characteristic module, the third contrast characteristic module is data of two finger gap characteristics of the three preset fingers which stretch straightly and contact each other, the real-time data module further includes a third characteristic module to be inspected, the third characteristic module to be inspected is data of two finger gaps to be inspected of the three fingers to be inspected which stretch straightly and contact each other, the processing unit contrasts the third characteristic module to be inspected and the third contrast characteristic module and obtains a third verification match rate; wherein when at least two of the first, second and third verification modules are greater than or equal to the preset match rate, the processing unit determines the three fingers to be inspected match the three preset fingers.

6. The fingerprint recognition system of a portable electronic device of claim 5, wherein the contrast data module further includes a fourth contrast characteristic module, the fourth contrast characteristic module is data of a plurality of knuckle print relative position characteristics of the three preset fingers which stretch straightly and contact each other, the real-time data module further includes a fourth characteristic module to be inspected, the fourth characteristic module to be inspected is data of a plurality of knuckle print relative positions to be inspected of the three fingers to be inspected which stretch straightly and contact each other, the processing unit contrasts the fourth characteristic module to be inspected and the fourth contrast characteristic module and obtains a fourth verification match rate; wherein when at least two of the first, second, third and fourth verification modules are greater than or equal to the preset match rate, the processing unit determines the three fingers to be inspected match the three preset fingers.

7. The fingerprint recognition system claim 6, wherein the preset match rate is defined as 80%, the three preset fingers and the three fingers to be inspected include a forefinger, a middle finger and a ring finger of a single hand, wherein when each of the first, second, third and fourth verification match rates is greater than or equal to the preset match rate, the processing unit determines the three fingers to be inspected match the three preset fingers.

8. The fingerprint recognition system of claim 1, wherein the three preset fingers and the three fingers to be inspected respectively include a forefinger, a middle finger and a ring finger of a single hand, the contrast data module further includes a fifth contrast characteristic module, when the three preset fingers strength straightly and contact each other, a first tangent line is defined to be tangent to a fingerprint contour of the middle finger and a fingerprint contour of the forefinger, a second tangent line is defined to be tangent to the fingerprint contour of the middle finger and a fingerprint contour of the ring finger, the first and second tangent lines cross with each other to form a preset included angle, the fifth contrast characteristic module is the included angle; the real-time data module further includes a fifth characteristic module to be inspected, when the three fingers to be inspected stretch straightly and contact each other, another first tangent line is defined to be tangent to the fingerprint contour of the middle finger and the fingerprint contour of the forefinger, another second tangent line is defined to be tangent to the fingerprint contour of the middle finger and the fingerprint contour of the ring finger, the first and second tangent lines of the three fingers to be inspected cross with each other to form an included angle to be inspected, the fifth characteristic module to be inspected is the included angle to be inspected; the processing unit contrasts the fifth characteristic module to be inspected and the fifth contrast characteristic module and obtains a fifth verification match rate; wherein when the fifth verification match rate is greater than or equal to the preset match rate, the processing unit determines the three fingers to be inspected match the three preset fingers.

9. The fingerprint recognition system of claim 1, wherein the three preset fingers and the three fingers to be inspected respectively include a forefinger, a middle finger and a ring finger of a single hand, the contrast data module further includes a sixth contrast characteristic module, when the three preset fingers strength straightly and contact each other, a preset datum line passes a knuckle print of a first knuckle of the middle finger, a distance between a knuckle print of a first knuckle of the forefinger and the preset datum line is a first preset distance, a distance between a knuckle print of a first knuckle of the ring finger and the datum line to be inspected is a second preset distance, the sixth contrast characteristic module is data of the first and second preset distances; the real-time data module further include a sixth characteristic module to be inspected, when the three fingers to be inspected stretch straightly and contact each other, a datum line to be inspected passes the knuckle print of the first knuckle of the middle finger, a distance between the knuckle print of the first knuckle of the forefinger and the datum line to be inspected is a first distance to be inspected, a distance between the knuckle print of the first knuckle of the ring finger and the preset datum line is a second distance to be inspected, the sixth characteristic module to be inspected is data of the first and second distances to be inspected; the processing unit contrasts the sixth characteristic module to be inspected and the sixth contrast characteristic module and obtains a sixth verification match rate; wherein when the sixth verification match rate is greater than or equal to the preset match rate, the processing unit determines the three fingers to be inspected match the three preset fingers.

10. The fingerprint recognition system of claim 1, wherein the three preset fingers and the three fingers to be inspected respectively include a forefinger, a middle finger and a ring finger of a single hand, the contrast data module further includes a seventh contrast characteristic module, when the three preset fingers strength straightly and contact each other, a preset polygon is defined through a plurality of preset characteristic points taken from knuckle prints of a first knuckle and a second knuckle of the middle finger, a knuckle print of a first knuckle of the forefinger and a knuckle print of a first knuckle of the ring finger, the seventh contrast characteristic module is data of the preset polygon; the real-time data module further includes a seventh characteristic module to be inspected, when the three fingers to be inspected stretch straightly and contact each other, a polygon to be inspected is defined through a plurality of characteristic points to be inspected taken from knuckle prints of the first knuckle and the second knuckle of the middle finger, the knuckle print of the first knuckle of the forefinger and the knuckle print of the first knuckle of the ring finger, the seventh characteristic module to be inspected is data of the polygon to be inspected; the processing unit contrasts the seventh characteristic module to be inspected and the seventh contrast characteristic module and obtains a seventh verification match rate; wherein when the seventh verification match rate is greater than or equal to the preset match rate, the processing unit determines the three fingers to be inspected match the three preset fingers.

11. The fingerprint recognition system of claim 1, wherein the three preset fingers and the three fingers to be inspected respectively include a forefinger, a middle finger and a ring finger of a single hand, the contrast data module further includes an eighth contrast characteristic module, when the three preset fingers strength straightly and contact each other, a distance between a knuckle print of a first knuckle of the forefinger to a finger tip of the forefinger is a first specified distance, a distance between a knuckle print of a first knuckle of the middle finger to a finger tip of the middle finger is a second specified distance, a distance between a knuckle print of a first knuckle of the ring finger to a finger tip of the ring finger is a third specified distance, the eighth contrast characteristic module is data of the first, second and third specified distances; the real-time data module further include an eighth characteristic module to be inspected, when the three fingers to be inspected stretch straightly and contact each other, the distance between the knuckle print of the first knuckle of the forefinger to the finger tip of the forefinger is a first specified distance to be inspected, the distance between the knuckle print of the first knuckle of the middle finger to the finger tip of the middle finger is a second specified distance to be inspected, the distance between the knuckle print of the first knuckle of the ring finger to a finger tip of the ring finger is a third specified distance to be inspected, the eighth characteristic module to be inspected is data of the first, second and third specified distances to be inspected; the processing unit contrasts the eighth characteristic module to be inspected and the eighth contrast characteristic module and obtains an eighth verification match rate; wherein when the eighth verification match rate is greater than or equal to the preset match rate, the processing unit determines the three fingers to be inspected match the three preset fingers.

12. The fingerprint recognition system claim 1, wherein the three preset fingers and the three fingers to be inspected respectively include a forefinger, a middle finger and a ring finger of a single hand, a distance between a knuckle print of a first knuckle and a knuckle print of a second knuckle of the forefinger of the three preset fingers is a fourth specified distance, a distance between a knuckle print of a first knuckle and a knuckle print of a second knuckle of the middle finger of the three preset fingers is a fifth specified distance, a distance between a knuckle print of a first knuckle and a knuckle print of a second knuckle of the ring finger of the three preset fingers is a sixth specified distance, the contrast data module further includes a ninth contrast characteristic module, the ninth contrast characteristic module is data of the fourth, fifth and sixth specified distances; the real-time data module further includes a ninth characteristic module to be inspected, the distance between the knuckle print of the first knuckle and the knuckle print of the second knuckle of the forefinger of the three fingers to be inspected is a fourth specified distance to be inspected, the distance between the knuckle print of the first knuckle and the knuckle print of the second knuckle of the middle finger of the three fingers to be inspected is a fifth specified distance to be inspected, the distance between the knuckle print of the first knuckle and the knuckle print of the second knuckle of the ring finger of the three fingers to be inspected is a sixth specified distance to be inspected, the ninth characteristic module to be inspected is data of the fourth, fifth and sixth specified distances to be inspected; the processing unit contrasts the ninth characteristic module to be inspected and the ninth contrast characteristic module and obtains a ninth verification match rate; wherein when the ninth verification match rate is greater than or equal to the preset match rate, the processing unit determines the three fingers to be inspected match the three preset fingers.

13. The fingerprint recognition system of claim 12, wherein the distances between the knuckle prints of the first knuckles and the knuckle prints of the second knuckles are farthest distances.

14. The fingerprint recognition system claim 12, wherein the distances between the knuckle prints of the first knuckles and the knuckle prints of the second knuckles are shortest distances.
